(19) United States
(12) Patent Application Publication
(10) Pub. No.: US 2007/0000711 A1
(43) Pub. Date: Jan. 4, 2007

(54) Passenger protection system for protecting passenger in vehicle from collision

(75) Inventors: Atsushi Yamaguchi, Nagoya-city (JP); Yukiyasu Ueno, Nishio-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/476,433

(22) Filed: Jun. 28, 2006

(30) Foreign Application Priority Data
Jul. 1, 2005 (JP) 2005-194195

(51) Int. Cl. B60K 28/10; E05F 15/00; B60Q 1/00

(52) U.S. Cl. 180/274; 280/735; 340/436; 701/45

(57) ABSTRACT

A passenger protection system includes: a first to third sensors for detecting an impact of the vehicle in a lateral direction of the vehicle; a determination element for determining a side collision of the vehicle on the basis of signals outputted from the first to third sensors; a first communication passage for connecting among the first and second sensors and the determination element to transmit signals from the first and second sensors to the determination element; and a second communication passage for connecting between the third sensor and the determination element to transmit a signal from the third sensor to the determination element.

### CROSS REFERENCE TO RELATED APPLICATION

This application is based on Japanese Patent Application No. 2005-194195 filed on Jul. 1, 2005, the disclosure of which is incorporated herein by reference.

### FIELD OF THE INVENTION

The present invention relates to a passenger protection system for protecting a passenger in a vehicle from a collision.

### BACKGROUND OF THE INVENTION

An automotive vehicle includes a passenger protection system for protecting a passenger in the vehicle from automotive collision. The system includes, for example, an air-bag system for protecting the passenger by inflating an air bag in case of the collision. Recently, it is required to protect the passenger from not only the collision in a front-back direction of the vehicle but also the collision in a side direction (i.e., a lateral direction) of the vehicle.

The system in a prior art is disclosed in, for example, U.S. Pat. No. 5,995,892, U.S. Pat. No. 5,904,723, U.S. Pat. No. 6,005479 and JP-A-2004-256026. The system includes a sensor for detecting the collision, and a determination means for determining the collision on the basis of a detection signal from the sensor. When the determination means determines that the vehicle collides against something, the system operates a protection means such as an air bag and a seat belt pre-tensioner.

In the system according to the prior art, multiple sensors for detecting the collision are mounted on multiple positions in the vehicle. Thus, the system includes multiple sensors, and each sensor is electrically connected to the determination means through an independent communication passage. Thus, each sensor and the determination means have a one-to-one relationship. In this case, even when one of the communication passages between the determination means and the sensors is broken, the system correctly receives other detection signals outputted from the sensors other than one of the sensors corresponding to the one of the communication passages. Specifically, even when a wire for the communication passage and/or an interface circuit (i.e., an I/F circuit) between each sensor and the determination means have trouble, bad effect from the troubled communication passage can be minimized to only one detection signal from the one sensor. Thus, even when one of the detection signals from the sensors is failed to receive correctly, the system can determines the collision on the basis of other signals from the sensors other than one failure signal, so that the determination means is prevented from misdeeming.

However, when the sensors are connected to the determination means through different passages, the system needs multiple I/F circuits. Accordingly, the dimensions of the determination means become large, so that mounting degree of freedom of the determination means is reduced.

Further, the number of the wires between the sensors and the determination means increases, and a total length of the wires becomes longer. Thus, a manufacturing cost of the system becomes higher.

### SUMMARY OF THE INVENTION

In view of the above-described problem, it is an object of the present disclosure to provide a passenger protection system for protecting a passenger in an automotive vehicle from collision.

According to an aspect of the present disclosure, a passenger protection system for an automotive vehicle includes: a first sensor for detecting an impact of the vehicle in a lateral direction of the vehicle; a second sensor for detecting the impact of the vehicle in the lateral direction of the vehicle; a third sensor for detecting the impact of the vehicle in the lateral direction of the vehicle; a determination element for determining a side collision of the vehicle on the basis of signals outputted from the first to third sensors; a first communication passage for connecting among the first sensor, the second sensor and the determination element in order to transmit signals outputted from the first sensor and the second sensor to the determination element; and a second communication passage for connecting between the third sensor and the determination element in order to transmit a signal outputted from the third sensor to the determination element.

In the above system, even of one of the communication passages has a difficulty, the other one of the communication passages functions for the determination of the determination element. Thus, by referring to a signal from the other one of the communication passage, the determination element can correctly determine the side collision without misdeeming the collision even if one of the communication passages has a difficulty. Further, multiple sensors are connected to the determination element with the common communication passage. Thus, the dimensions of the system are minimized, and further, the above system has high reliability.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic top view showing a passenger protection system according to a first embodiment of the present invention;

FIG. 2 is a block diagram showing around an ECU in the system according to the first embodiment;

FIG. 3 is a flow chart explaining operation of the system according to the first embodiment;

FIG. 4 is a schematic top view showing a passenger protection system according to a second embodiment of the present invention;

FIG. 5 is a flow chart explaining operation of the system according to the second embodiment;

FIG. 6 is a schematic top view showing a passenger protection system according to a third embodiment of the present invention;

FIG. 7 is a flow chart explaining operation of the system according to the third embodiment;

FIG. 8 is a schematic top view showing a passenger protection system according to a first modification of the embodiments;

FIG. 9 is a schematic top view showing a passenger protection system according to a second modification of the embodiments; and

FIG. 10 is a schematic top view showing a passenger protection system according to a third modification of the embodiments.

### DETAILED DESCRIPTION OF THE PREFERRED EMBODIMENTS

### First Embodiment

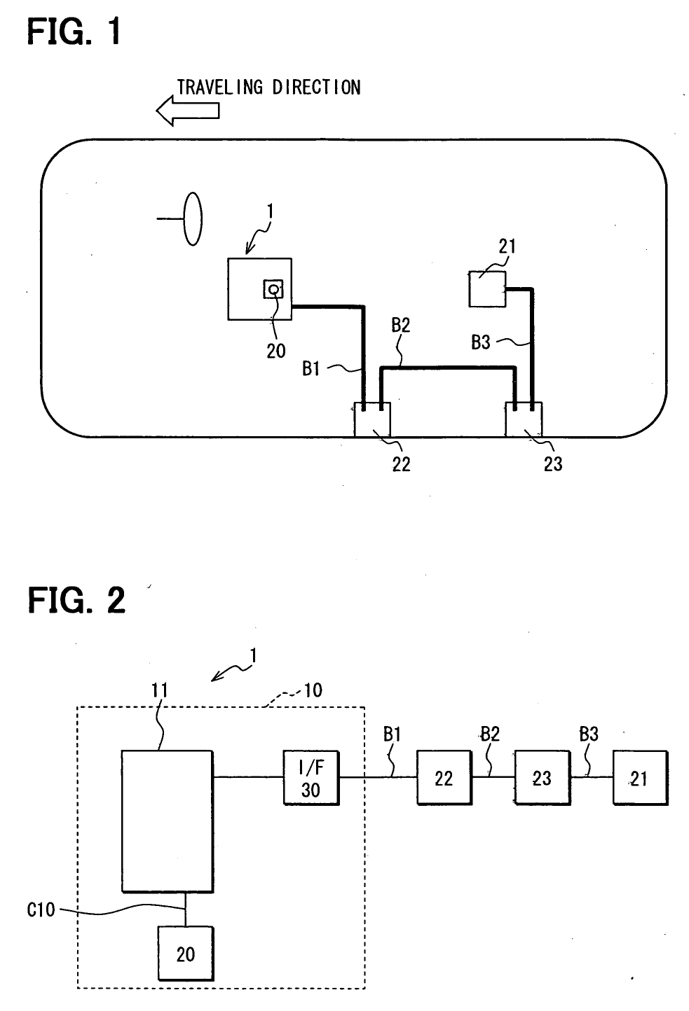

FIGS. 1 and 2 show a passenger protection system according to a first embodiment of the present disclosure. The system includes an electric control unit (i.e., ECU) 1, multiple associate sensors (i.e., satellite sensors) 21-23 and multiple bus lines B1-B3. The bus lines B1-B3 connect among the ECU 1 and the sensors 21-23.

The ECU 1 is disposed near the center of an automotive vehicle. The ECU 1 determines a collision of the vehicle such as a collision in a side direction of the vehicle, and controls to operate a passenger protection unit such as an air bag system. As shown in FIG. 2, the ECU 1 includes a circuit board 10 and a CPU, i.e., a central processing unit 11, which is mounted on the board 10. The ECU 1 corresponds to a determination means, and the CPU 11 corresponds to a determination element. A wiring C10 connects between the CPU 11 and the lateral acceleration sensor 20. The wiring C10 provides a second communication passage.

A lateral acceleration sensor 20 is mounted on the circuit board 10. The sensor 20 detects acceleration in a lateral direction, i.e., a side direction, of the vehicle. The lateral acceleration sensor 20 is coupled with the CPU 11. The lateral acceleration sensor 20 detects a collision in the lateral direction occurred near a front seat of the vehicle, i.e., a driver's seat and a front passenger's seat. Here, the lateral acceleration sensor 20 represents a safing sensor.

Each associate sensor 21-23 is disposed outside of the ECU 1, and disposed on each position of the vehicle. The associate sensor 21-23 detects a vehicle condition. The associate sensors 21-23 include a vehicle center sensor 21, a front seat left side sensor 22 and a rear seat left side sensor 23. The vehicle center sensor 21 is a lateral acceleration sensor, the front seat left side sensor 21 is a first row left side sensor, and the rear seat left side sensor 22 is a second row left side sensor.

The vehicle center sensor 21 is disposed on the center line of the vehicle in the lateral direction, and disposed on a rear side from the ECU 1. The vehicle center sensor 21 is disposed between the front seat left side sensor 21 and the rear seat left side sensor 22 in the front-back direction of the vehicle. The vehicle center sensor 21 detects the vehicle condition such as a lateral acceleration in the lateral direction of the vehicle. The vehicle center sensor 21 is a safing sensor for detecting the side collision near the second row, i.e., the rear seat of the vehicle.

The front seat left side sensor 22 is disposed on the left side of the vehicle, and disposed on the front seat side of the vehicle. Thus, the front seat left side sensor 22 is disposed on the left side of the front passenger seat. Specifically, the front seat left side sensor 22 is disposed near a left side center pillar, i.e., a left side B pillar of the vehicle. The rear seat left side sensor 23 is disposed on the left side of the vehicle, and disposed on the rear seat side of the vehicle. Thus, the rear seat left side sensor 23 is disposed on the left side of the rear passenger seat behind the front passenger seat. Specifically, the rear seat left side sensor 23 is disposed near a left side back pillar, i.e., a left side C pillar of the vehicle. Each of the front seat left side sensor 22 and the rear seat left side sensor 23 is a main sensor for detecting the side collision near the position, on which the sensor is mounted. Each of the front seat left side sensor 22 and the rear seat left side sensor 23 is a lateral acceleration sensor for detecting a lateral acceleration in the lateral direction of the vehicle.

The bus lines B1-B3 connect between the ECU 1 and the associate sensor 22 and between the associate sensors 21-23. Specifically, the bus line B1 connects between the ECU 1 and the front seat left side sensor 22. The bus line B2 connects between the front seat left side sensor 22 and the rear seat left side sensor 23. The bus line B3 connects between the rear seat left side sensor 23 and the vehicle center sensor 21.

As shown in FIG. 2, the bus line B1 is connected to the CPU 11 through a bus interface 30. The bus interface 30 is disposed on the circuit board 10. In the passenger protection system, an acceleration signal outputted from each sensor 20-23 is inputted into the CPU 11 through a communication passage with the bus interface 30 and through another communication passage between the CPU 11 and the lateral acceleration sensor 20. Thus, the bus interface 30 and the bus lines B1-B3 provide the same communication passage.

The system further includes a passenger protection unit (not shown). The passenger protection unit starts to function on the basis of an operation signal outputted from the ECU 1 when the ECU 1 determines the side collision of the vehicle. The unit includes a right side air bag, a left side air bag, a right side curtain air bag, a left side curtain air bag, a right side seat belt pre-tensioner, a left side seat belt pre-tensioner and the like. The unit is provided by a conventional unit.

The vehicle center sensor 21 as the safing sensor and the rear seat left side sensor 23 as the main sensor for detecting the side collision on the left side near the rear seat are connected to the CPU 11 through the same communication passage. Accordingly, the lateral acceleration sensor 20 is used as a third sensor for detecting the side collision on the left side near the rear seat. Here, the lateral acceleration sensor 20 is the safing sensor for detecting the side collision near the front seat. Thus, since the vehicle center sensor functions for detecting not only the side collision near the front seat but also the side collision near the rear seat, the manufacturing cost of the system is reduced.

[Normal Operation]

Operation of the passenger protection system is explained in a case where the side collision occurred at the left side of the rear seat of the vehicle. When the side collision occurs, each sensor 20-23 detects the lateral acceleration in the lateral direction of the vehicle. Then, the detection signal from each sensor 20-23 is inputted into the CPU 11.

The acceleration signal as an analog voltage signal outputted from the lateral acceleration sensor 20 is directly inputted into the CPU 1. Then, the signal is processed in an A/D converting step so that the analog signal is converted into a digital signal in the CPU 11. This process of the acceleration signal from the lateral acceleration sensor 20 also provides the communication passage.

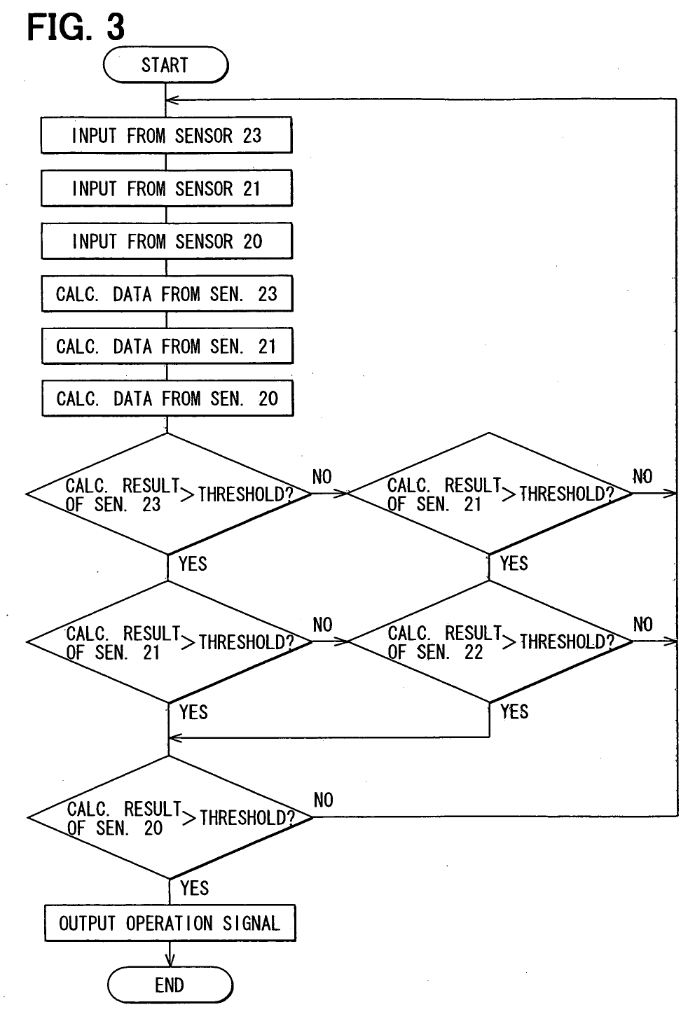

The CPU 11 determines the side collision occurred on the left side of the rear seat of the vehicle on the basis of the acceleration signal inputted into the CPU 11. Specifically, as shown in FIG. 3, an acceleration signal outputted from each of the rear seat left side sensor 23, the vehicle center sensor 21 and the lateral acceleration sensor 20 is inputted into the CPU 11. Each data of the acceleration signal from the sensors 20, 21, 23 is calculated by the CPU 11 so that a calculation result is obtained. The calculation result from the rear seat left side sensor 23 is compared with a predetermined threshold of the sensor 23, and further, the calculation result from the vehicle center sensor 21 is compared with a predetermined threshold of the sensor 21. When the calculation result from the sensor 23 is larger than the threshold of the sensor 23, and further, the calculation result from the sensor 21 is larger than the threshold of the sensor 21, it goes to the next step. In the next step, the calculation result from the lateral acceleration sensor 20 is compared with a predetermined threshold of the sensor 20. When the calculation result from the sensor 20 is larger than the threshold of the sensor 20, the CPU determines that the side collision is occurred on the left side of the rear seat.

When one of the calculation results from the sensors 21, 23 is larger than the corresponding threshold of the sensor 21, 23, the calculation result from the front seat left side sensor 22 is compared with a predetermined threshold of the sensor 22. When the calculation result from the sensor 22 is larger than the threshold of the sensor 22, the calculation result from the lateral acceleration sensor 20 is compared with the threshold of the sensor 20. When the calculation result from the sensor 20 is larger than the threshold of the sensor 20, the CPU determines that the side collision is occurred on the left side of the rear seat.

The threshold of the rear seat left side sensor 23 as the main sensor is the largest among the thresholds of the sensors 20-23, since the impact of the side collision on the lefts side of the rear seat is the largest. The threshold of the vehicle center sensor 21 as the safing sensor is smaller than the threshold of the rear seat left side sensor 23. Further, the threshold of the lateral acceleration sensor 20 as the third sensor is set to be smaller. The threshold of the safing sensor is determined in view of an acceleration generated in case of vehicle turn at high speed, sensor output error, A/D conversion error. For example, the threshold of the safing sensor is set to be 19.6 m/s², which corresponds to 2G, and is defined as an average acceleration for 4 milliseconds. The impact of the collision applied to the lateral acceleration sensor 20 as the third sensor is the smallest among the impacts applied to the sensor 20-23, since the lateral acceleration sensor 20 is disposed on the farthest position from the side collision among the sensors 20-23. Further, the response time of the lateral acceleration sensor 20 is the latest among the sensors 20-23. Accordingly, it is preferred that the threshold of the lateral acceleration sensor 20 is set to be smaller than that of the safing sensor. For example, the threshold of the lateral acceleration sensor 20 is determined by subtracting a value corresponding to the acceleration generated in case of vehicle turn at high speed from the threshold of the safing sensor. Specifically, the threshold of the lateral acceleration sensor 20 is set to be 9.8 m/s², which corresponds to 2G, and is defined as an average acceleration for 4 milliseconds. Thus, a response delay between the collision time and the determination time is compensated or reduced. If the response delay is small, the threshold of the safing sensor is set to be almost the same as the threshold of the third sensor.

When the CPU 11 in the ECU 1 determines that the side collision is occurred on the left side of the rear seat, the ECU 1 outputs the operation signal to the passenger protection unit. Thus, the passenger protection unit starts to function.

[Anomaly Signal Operation]

Next, a case where one of the bus lines B1-B3 and/or one of the bus interface 30 and the sensors 20-23 have a difficulty is explained. Here, the bus lines B1-B3, the bus interface 30 and the sensors 20-23 are used for the determination of the side collision from the left side.

If the bus line B1 is broken, all acceleration signals outputted from the front seat left side sensor 22, the rear seat left side sensor 23 and the vehicle center sensor 21 are not inputted into the CPU 11, so that the side collision cannot be detected by the passenger protection system. If the bus line B2 is broken, the acceleration signals outputted from the rear seat left side sensor 23 and the vehicle center sensor 21 are not inputted into the CPU 11, so that the side collision near the rear seat cannot be detected by the passenger protection system. If the bus interface 30 is broken so that the communication between the bus line B1 and the CPU 11 is not performed, the side collision cannot be detected by the passenger protection system. Thus, in the above cases regarding the difficulties of the bus lines B1, B2 and the bus interface 30, the ECU 1 does not mistakenly determine the side collision.

If one of the sensors 20-23 fails to output the acceleration signal, the system does not have sufficient acceleration signals to determine the side collision by the CPU 11. Accordingly, in this case, the determination of the side collision may be stopped, or the determination of the side collision may be performed by residual sensors other than a defective sensor. Thus, even if one of the sensors 20-23 fails to output the acceleration signal, the ECU 1 does not mistakenly determine the side collision.

If the bus interface 30 has a difficulty regarding the communication passage, or if the bus lines B1-B3 accept electric noise influence, the acceleration signals from the sensors 21-23 may be disturbed. In this case, the disturbed signal may be inputted into the CPU 11, the disturbed signal having almost the same magnitude as the acceleration signal in case of the side collision. When the disturbed signal is inputted in the CPU 11, finally, the CPU 11 compares the calculation result of the acceleration signal from the lateral acceleration sensor 20 with the threshold of the sensor 20. In the above case, since the disturbed signal inputted through the bus lines B1-B3 is a noise signal, the lateral acceleration sensor 20 does not detect the acceleration in the lateral direction of the vehicle. Accordingly, the calculation result of the acceleration signal from the lateral acceleration sensor 20 is equal to or smaller than the threshold of the sensor 20. Thus, the CPU 11 does not determine that the side collision is occurred. Further, even if one of the sensor 20-23 outputs an improper signal having almost the same magnitude as the acceleration signal in case of the side collision, the CPU 11 also does not determine that the side collision is occurred.

Thus, in the passenger protection system, the ECU 1 does not mistakenly determine that the side collision is occurred even if one of the bus lines B1-B3 or the bus interface 30 has a failure. The CPU 11 does not mistakenly determine that the side collision is occurred, so that the CPU 11 does not mistakenly output the operation signal. Accordingly, even if one of the bus lines B1-B3, the bus interface 30 and the sensors 20-23 has a failure, the passenger protection unit does not mistakenly function.

### Second Embodiment

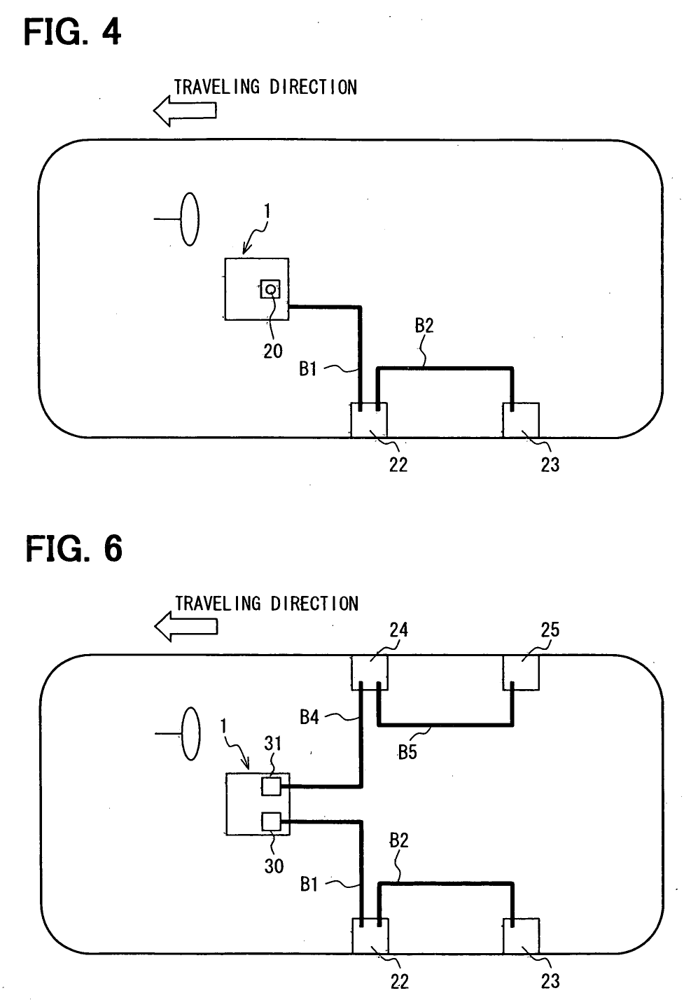

A passenger protection system according to a second embodiment of the present invention is shown in FIG. 4. The system does not include the vehicle center sensor 21 and the bus line B3.

The lateral acceleration sensor 20 is a safing sensor for detecting the side collision near the front seat. The front seat left side sensor 22 and the rear seat left side sensor 23 are main sensors for detecting the side collision near the left side of the front seat and near the left side of the rear seat, respectively. The front seat left side sensor 22 also functions as a safing sensor for detecting the side collision on the left side of the rear seat. The rear seat left side sensor 23 as the main sensor and the front seat left side sensor 22 as the safing sensor for detecting the side collision on the left side of the rear seat are connected to the same communication passage. The lateral acceleration sensor 20 is used for the third sensor for detecting the side collision on the left side of the rear seat.

[Normal Operation]

Operation of the passenger protection system is explained in a case where the side collision occurred at the left side of the rear seat of the vehicle. When the side collision occurs, each sensor 20, 22, 23 detects the lateral acceleration in the lateral direction of the vehicle. Then, the detection signal from each sensor 20, 22, 23 is inputted into the CPU 11.

The acceleration signal as an analog voltage signal outputted from the lateral acceleration sensor 20 is directly inputted into the CPU 1. Then, the signal is processed in an A/D converting step so that the analog signal is converted into a digital signal in the CPU 11. This process of the acceleration signal from the lateral acceleration sensor 20 also provides the communication passage.

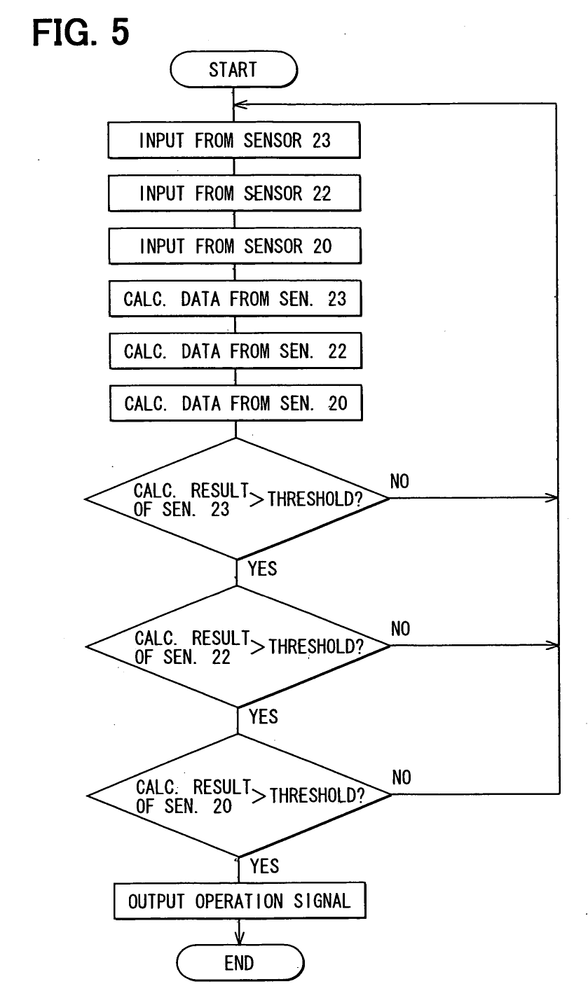

The CPU 11 determines the side collision occurred on the left side of the rear seat of the vehicle on the basis of the acceleration signal inputted into the CPU 11. Specifically, as shown in FIG. 5, an acceleration signal outputted from each of the rear seat left side sensor 23, the front seat left side sensor 22 and the lateral acceleration sensor 20 is inputted into the CPU 11. Each data of the acceleration signals from the sensors 20, 22, 23 is calculated by the CPU 11 so that a calculation result is obtained. The calculation result from the rear seat left side sensor 23 is compared with a predetermined threshold of the sensor 23, and further, the calculation result from the front seat left side sensor 22 is compared with a predetermined threshold of the sensor 22. When the calculation result from the sensor 23 is larger than the threshold of the sensor 23, and further, the calculation result from the sensor 22 is larger than the threshold of the sensor 22, it goes to the next step. In the next step, the calculation result from the lateral acceleration sensor 20 is compared with a predetermined threshold of the sensor 20. When the calculation result from the sensor 20 is larger than the threshold of the sensor 20, the CPU determines that the side collision is occurred on the left side of the rear seat.

The threshold of the rear seat left side sensor 23 as the main sensor is the largest among the thresholds of the sensors 20, 22, 23, since the impact of the side collision on the lefts side of the rear seat is the largest. The threshold of the front seat left side sensor 22 as the safing sensor is smaller than the threshold of the rear seat left side sensor 23. Further, the threshold of the lateral acceleration sensor 20 as the third sensor is set to be smaller. The threshold of the safing sensor is determined in view of an acceleration generated in case of vehicle turn at high speed, sensor output error, A/D conversion error and a margin. For example, the threshold of the safing sensor is set to be 19.6 m/s², which corresponds to 2G, and is defined as an average acceleration for 4 milliseconds. The impact of the collision applied to the lateral acceleration sensor 20 as the third sensor is the smallest among the impacts applied to the sensor 20, 22, 23, since the lateral acceleration sensor 20 is disposed on the farthest position from the side collision among the sensors 20, 22, 23. Further, the response time of the lateral acceleration sensor 20 is the latest among the sensors 20, 22, 23. Accordingly, it is preferred that the threshold of the lateral acceleration sensor 20 is set to be smaller than that of the safing sensor. For example, the threshold of the lateral acceleration sensor 20 is determined by subtracting a value corresponding to the acceleration generated in case of vehicle turn at high speed from the threshold of the safing sensor. Specifically, the threshold of the lateral acceleration sensor 20 is set to be 9.8 m/s², which corresponds to 2G, and is defined as an average acceleration for 4 milliseconds. Thus, a response delay between the collision time and the determination time is compensated or reduced. If the response delay is small, the threshold of the safing sensor is set to be almost the same as the threshold of the third sensor.

When the CPU 11 in the ECU 1 determines that the side collision is occurred on the left side of the rear seat, the ECU 1 outputs the operation signal to the passenger protection unit. Thus, the passenger protection unit starts to function.

[Anomaly Signal Operation]

Next, a case where one of the bus lines B1-B2 and/or one of the bus interface 30 and the sensors 20-23 have a difficulty is explained. Here, the bus lines B1-B2, the bus interface 30 and the sensors 20-23 are used for the determination of the side collision from the left side.

If the bus line B1 is broken, all acceleration signals outputted from the front seat left side sensor 22 and the rear seat left side sensor 23 are not inputted into the CPU 11, so that the side collision cannot be detected by the passenger protection system. If the bus line B2 is broken, the acceleration signals outputted from the rear seat left side sensor 23 is not inputted into the CPU 11, so that the side collision near the rear seat cannot be detected by the passenger protection system. If the bus interface 30 is broken so that the communication between the bus line B1 and the CPU 11 is not performed, the side collision cannot be detected by the passenger protection system. Thus, in the above cases regarding the difficulties of the bus lines B1, B2 and the bus interface 30, the ECU 1 does not mistakenly determine the side collision.

If one of the sensors 20, 22, 23 fails to output the acceleration signal, the system does not have sufficient acceleration signals to determine the side collision by the CPU 11. Accordingly, in this case, the determination of the side collision may be stopped, or the determination of the side collision may be performed by residual sensors other than a defective sensor. Thus, even if one of the sensors 20-23 fails to output the acceleration signal, the ECU 1 does not mistakenly determine the side collision.

If the bus interface 30 has a difficulty regarding the communication passage, or if the bus lines B1-B2 accept electric noise influence, the acceleration signals from the sensors 22-23 may be disturbed. In this case, the disturbed signal may be inputted into the CPU 11, the disturbed signal having almost the same magnitude as the acceleration signal in case of the side collision. When the disturbed signal is inputted in the CPU 11, finally, the CPU 11 compares the calculation result of the acceleration signal from the lateral acceleration sensor 20 with the threshold of the sensor 20. In the above case, since the disturbed signal inputted through the bus lines B1-B2 is a noise signal, the lateral acceleration sensor 20 does not detect the acceleration in the lateral direction of the vehicle. Accordingly, the calculation result of the acceleration signal from the lateral acceleration sensor 20 is equal to or smaller than the threshold of the sensor 20. Thus, the CPU 11 does not determine that the side collision is occurred. Further, even if one of the sensor 20, 22, 23 outputs an improper signal having almost the same magnitude as the acceleration signal in case of the side collision, the CPU 11 also does not determine that the side collision is occurred.

Thus, in the passenger protection system, the ECU 1 does not determine that the side collision is occurred even if one of the bus lines B1-B2 or the bus interface 30 has a failure. The CPU 11 does not mistakenly determine that the side collision is occurred, so that the CPU does not mistakenly output the operation signal. Accordingly, even if one of the bus lines B1-B2, the bus interface 30 and the sensors 20-23 has a failure, the passenger protection unit does not mistakenly function.

### Third Embodiment

A passenger protection system according to a third embodiment of the present invention is shown in FIG. 6. The system does not include the lateral acceleration sensor 20, the vehicle center sensor 21 and the bus line B3. Instead, the system includes a front seat right side sensor 24, a rear seat right side sensor 25, and two bus lines B4-B5. The front seat right side sensor 24 and the rear seat right side sensor 25 as an associate sensor detect the side collision on the right side of the vehicle.

Each associate sensor 24-25 is disposed outside of the ECU 1, and disposed on each position of the vehicle. The associate sensor 24-25 detects a vehicle condition. The associate sensors 24-25 include the front seat right side sensor 24 and the rear seat right side sensor 25. The front seat right side sensor 24 is a first row left side sensor, and the rear seat right side sensor 25 is a second row left side sensor.

The front seat right side sensor 24 is disposed on the right side of the vehicle, and disposed on the front seat side of the vehicle. Thus, the front seat right side sensor 24 is disposed on the right side of the front driver seat. Specifically, the front seat right side sensor 24 is disposed near a right side center pillar, i.e., a right side B pillar of the vehicle. The rear seat right side sensor 25 is disposed on the right side of the vehicle, and disposed on the rear seat side of the vehicle. Thus, the rear seat right side sensor 25 is disposed on the right side of the rear passenger seat behind the front driver seat. Specifically, the rear seat right side sensor 25 is disposed near a right side back pillar, i.e., a right side C pillar of the vehicle. Each of the front seat right side sensor 24 and the rear seat right side sensor 25 is a main sensor for detecting the side collision near the position, on which the sensor 24, 25 is mounted. Each of the front seat right side sensor 24 and the rear seat right side sensor 25 is a lateral acceleration sensor for detecting a lateral acceleration in the lateral direction of the vehicle.

The bus lines B4-B5 connect between the ECU 1 and the associate sensor 24 and between the associate sensors 24-25. Specifically, the bus line B4 connects between the ECU 1 and the front seat right side sensor 24. The bus line B5 connects between the front seat right side sensor 24 and the rear seat right side sensor 25.

The bus line B4 is connected to the CPU 11 through a bus interface 31 (not shown). The bus interface 31 is disposed on the circuit board 10. In the passenger protection system, an acceleration signal outputted from each sensor 22-23, 24-25 is inputted into the CPU 11 through a communication passage with the bus interfaces 30, 31. Thus, the bus interface 30 and the bus lines B1-B2 provide the same communication passage. The bus interface 31 and the bus lines B4-B5 provide the same communication passage, which is different passage of the bus interface 30 and the bus lines B1-B2.

The system includes a communication passage including the front and rear seat left side sensors 22-23 and another communication passage including the front and rear seat right side sensors 24-25. Two communication passages are disposed symmetrically with a center line of the vehicle perpendicular to the lateral direction. The sensors 22-25 are main sensors for detecting the side collision near the position, on which the sensor is mounted. The front seat left side sensor 22 also functions as a safing sensor for detecting the side collision on the left side of the rear seat. The rear seat left side sensor 23 also functions as a safing sensor for detecting the side collision on the left side of the front seat. The front seat left side sensor 22 and the rear seat left side sensor 23 for detecting the side collision functioning as the main sensor and the safing sensor are connected to the same communication passage. The front seat right side sensor 24 also functions as a safing sensor for detecting the side collision on the right side of the rear seat. The rear seat right side sensor 25 also functions as a safing sensor for detecting the side collision on the right side of the front seat. The front seat right side sensor 24 and the rear seat right side sensor 25 for detecting the side collision functioning as the main sensor and the safing sensor are connected to the same communication passage.

A sensor disposed on opposite and symmetric side of a main sensor with the center line of the vehicle also functions as a second safing sensor. Thus, in this case, the second safing sensor functions as a third sensor. Specifically, the front seat right side sensor 24 functions as the second safing sensor for detecting the side collision of the left side of the front seat. The front seat left side sensor 22 functions as the second safing sensor for detecting the side collision of the right side of the front seat. The rear seat right side sensor 25 functions as the second safing sensor for detecting the side collision of the left side of the rear seat. The rear seat left side sensor 23 functions as the second safing sensor for detecting the side collision of the right side of the rear seat.

[Normal Operation]

Operation of the passenger protection system is explained in a case where the side collision occurred at the left side of the rear seat of the vehicle. When the side collision occurs, each sensor 22-25 detects the lateral acceleration in the lateral direction of the vehicle. Then, the detection signal from each sensor 22-25 is inputted into the CPU 11.

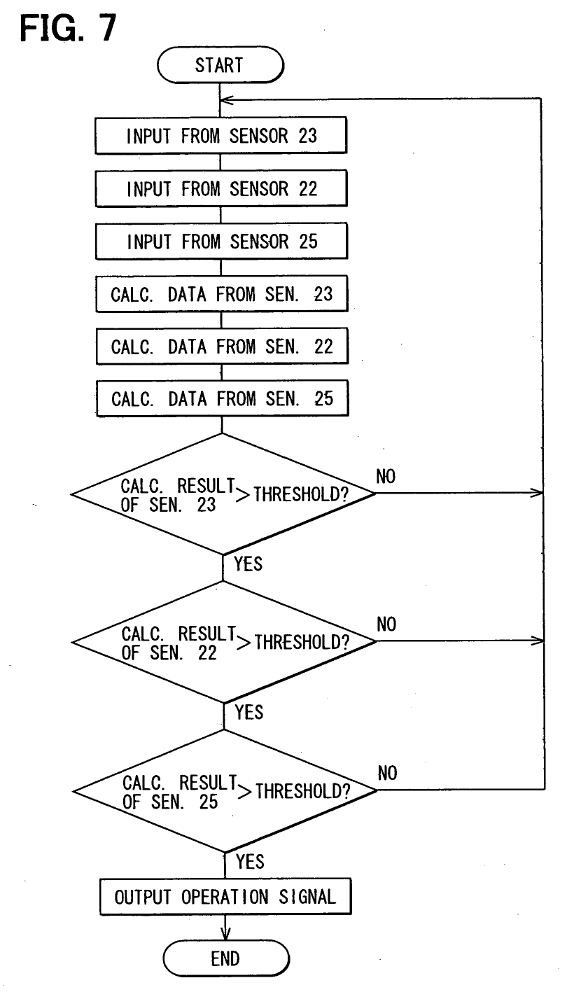

The CPU 11 determines the side collision occurred on the left side of the rear seat of the vehicle on the basis of the acceleration signals inputted into the CPU 11. Specifically, as shown in FIG. 7, an acceleration signal outputted from each of the rear seat left side sensor 23, the front seat left side sensor 22 and the rear seat right side sensor 25 is inputted into the CPU 11. Each data of the acceleration signal from the sensors 22, 23, 25 is calculated by the CPU 11 so that a calculation result is obtained. The calculation result from the rear seat left side sensor 23 is compared with a predetermined threshold of the sensor 23. When the calculation result from the sensor 23 is larger than the threshold of the sensor 23, the calculation result from the front seat left side sensor 22 is compared with a predetermined threshold of the sensor 22. When the calculation result from the sensor 22 is larger than the threshold of the sensor 22, the calculation result from the rear seat right side sensor 25 is compared with a predetermined threshold of the sensor 25. When the calculation result from the sensor 25 is larger than the threshold of the sensor 25, the CPU determines that the side collision is occurred on the left side of the rear seat.

The threshold of the rear seat left side sensor 23 as the main sensor is the largest among the thresholds of the sensors 22-25, since the impact of the side collision on the lefts side of the rear seat is the largest. The threshold of the front seat left side sensor 22 as the safing sensor is smaller than the threshold of the rear seat left side sensor 23. Further, the threshold of the rear seat right side sensor 25 as the third sensor is set to be smaller.

When the CPU 11 in the ECU 1 determines that the side collision is occurred on the left side of the rear seat, the ECU 1 outputs the operation signal to the passenger protection unit. Thus, the passenger protection unit starts to function.

In the system, the ECU 1 determines the side collision on the basis of the signal outputted from the rear seat right side sensor 25. Thus, in the passenger protection system, the ECU 1 does not determine that the side collision is occurred even if one of the bus lines B1-B2, B4-B5 or the bus interface 30 has a failure. The CPU 11 does not mistakenly determine that the side collision is occurred, so that the CPU 11 does not mistakenly output the operation signal. Accordingly, even if one of the bus lines B1-B2, B4-B5, the bus interface 30 and the sensors 22-25 has a failure, the passenger protection unit does not mistakenly function.

Although the system includes the rear seat right side sensor 25, the system may include the front seat right side sensor 24 as the third sensor so that the CPU 11 in the ECU 1 determines the side collision on the basis of the signal from the front seat right side sensor 24.

Thus, even if one of the bus lines B1-B2, B4-B5, the bus interface 30 and the sensors 22-25 has a failure, the passenger protection unit does not mistakenly function. Accordingly, the system has high reliability.

(Modifications)

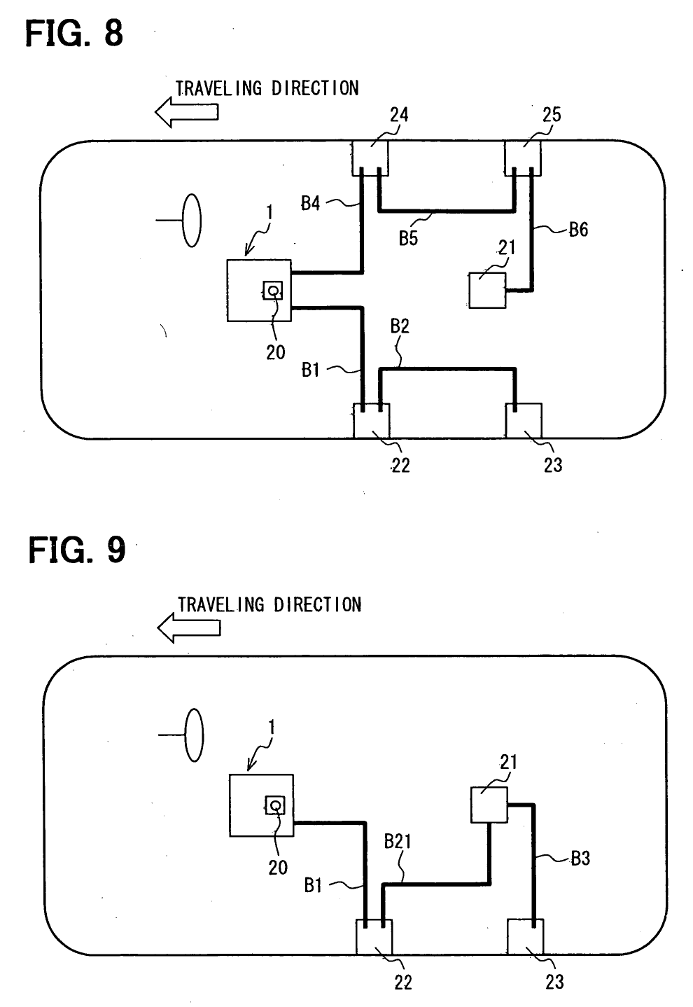

A passenger protection system according to a first modification of the embodiments is shown in FIG. 8. The system includes the satellite sensors 24, 25 and the bus lines B4-B5 for detecting the right side collision. Further, the system includes the vehicle center sensor 21 connecting to the rear seat right side sensor 25. The vehicle center sensor 21 is connected to the rear seat right side sensor 25 through a bus line B6. The vehicle center sensor 21 functions as the safing sensor for detecting the side collision on the right side of the rear seat. The lateral acceleration sensor 20 functions as the safing sensor for detecting the side collision on the right side or the left side of the front seat. Further, the lateral acceleration sensor 20 functions as the second safing sensor for detecting the collision on the right side of the rear seat.

A passenger protection system according to a second modification of the embodiments is shown in FIG. 9. The bus line B21 connects between the front seat left side sensor 22 and the vehicle center sensor 21. The bus line B3 connects between the vehicle center sensor 21 and the rear seat left side sensor 23.

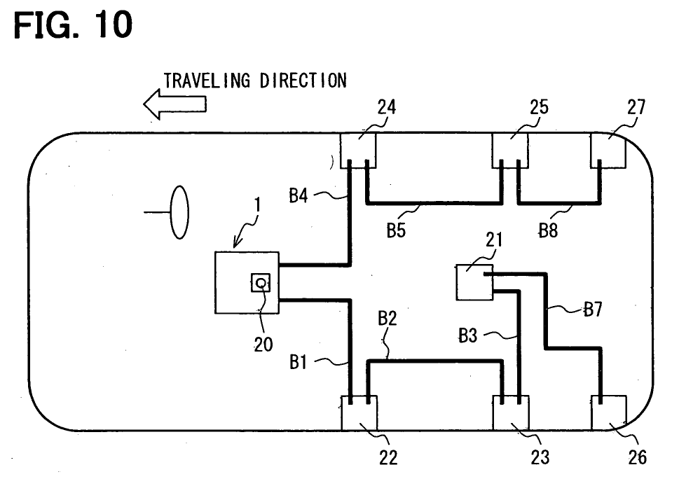

A passenger protection system according to a third modification of the embodiments is shown in FIG. 10. The system includes the sensors 20-25, a third row left side sensor 26, a third row right side sensor 27, the bus lines B1-B5, and two new bus lines B7-B8. Each of the third row left side sensor 26 and the third row right side sensor 27 as a satellite sensor detects the side collision near the third seat of the vehicle in the lateral direction of the vehicle. The third row left side sensor 26 is disposed near a left side rear pillar, i.e., a left side D pillar of the vehicle. The third row right side sensor 27 is disposed near a right side rear pillar, i.e., a right side D pillar of the vehicle.

The third row left side sensor 26 is connected to the vehicle center sensor 21 through the bus line B7. The third row right side sensor 27 is connected to the vehicle center sensor 21 through the bus line B7. The bus interface 30 and the bus lines B1-B3, B7 provide the same communication passage. The bus interface 31 and the bus lines B4-B5, B8 provide the same communication passage. The third row left side sensor 26 functions as the main sensor for detecting the side collision on the left side of the third row of the vehicle. The vehicle center sensor 21 functions as the safing sensor, and the third row right side sensor 27 functions as the third sensor, in order to detect the side collision of the left side of the third row of the vehicle. Alternatively, the rear seat right side sensor 25 may function as the third sensor for detecting the side collision of the left side of the third row of the vehicle.

The above sensors 20-27 may be any kind of a sensor as long as the sensor can detect a displacement caused by the impact in the lateral direction of the vehicle. For example, the sensors 20-27 may be formed from an acceleration sensor or a compartment inner pressure sensor, i.e., a door inner pressure sensor.

The present disclosure has the following aspects.

According to an aspect of the present disclosure, a passenger protection system for an automotive vehicle includes: a first sensor for detecting an impact of the vehicle in a lateral direction of the vehicle; a second sensor for detecting the impact of the vehicle in the lateral direction of the vehicle; a third sensor for detecting the impact of the vehicle in the lateral direction of the vehicle; a determination element for determining a side collision of the vehicle on the basis of signals outputted from the first to third sensors; a first communication passage for connecting among the first sensor, the second sensor and the determination element in order to transmit signals outputted from the first sensor and the second sensor to the determination element; and a second communication passage for connecting between the third sensor and the determination element in order to transmit a signal outputted from the third sensor to the determination element.

In the above system, even of one of the communication passages has a difficulty, the other one of the communication passages functions for the determination of the determination element. Thus, by referring to a signal from the other one of the communication passage, the determination element can correctly determine the side collision without misdeeming the collision even if one of the communication passages has a difficulty. Further, multiple sensors are connected to the determination element with the common communication passage. Thus, the dimensions of the system are minimized, and further, the above system has high reliability.

Alternatively, the determination element may determine that the side collision is occurred when the impact of the vehicle corresponding to the signal of each sensor is larger than a predetermined threshold of the sensor. In this case, when each impact detected by the sensors is larger than the threshold of each sensor, the determination element determines the side collision. Thus, the determination element is prevented from misdeeming the collision even if one of the communication passages has a difficulty.

Further, the threshold of the third sensor may be smaller than the threshold of the first sensor, and smaller than the threshold of the second sensor. In this case, even if the third sensor is disposed far from the side collision portion of the vehicle, the determination element determines the side collision without delaying response substantially.

Alternatively, the first sensor and the second sensor may be disposed on one side of the vehicle so that each of the first sensor and the second sensor functions as a satellite sensor. One of the first sensor and the second sensor functions as a main sensor for determination of the collision, and the other one of the first sensor and the second sensor functions as a sub sensor for the determination of the collision. The third sensor prevents the determination element from misdeeming even if the first communication passage has a difficulty. The third sensor may be used for the determination of the side collision, or only for prevention of misdeeming.

Further, the third sensor may be disposed in the determination element, and the third sensor may be an acceleration sensor. In this case, the system has high reliability without adding new satellite sensor and wiring between the new satellite sensor and the third sensor.

Further, the sub sensor may be disposed on a center of the vehicle in the lateral direction of the vehicle. In this case, the sub sensor and the main sensor are connected to the bus interface through the same communication passage without adding a new bus interface.

Alternatively, the first sensor and the second sensor may be disposed on one side of the vehicle so that each of the first sensor and the second sensor functions as a satellite sensor, and the third sensor may be disposed on the other side of the vehicle so that the third sensor functions as another satellite sensor. Further, the system may include other sensors so that the determination accuracy of the side collision is improved. The total number of the sensors in the system may be equal to or more than 4. A newly added sensor may be connected to the determination element through the first communication passage, the second communication passage or another new communication passage.

Alternatively, the system further includes a passenger protection unit functioning on the basis of the determination of the determination element.

Alternatively, the first sensor may be disposed on one side of the vehicle, the second sensor may be disposed on a center of the vehicle so that the second sensor and the first sensor are disposed on almost a same latitudinal line of the vehicle, and the third sensor may be disposed on the center of the vehicle so that the third sensor is apart from the second sensor. The first sensor is a main sensor for detecting the impact on the one side of the vehicle, the second sensor is a first sub sensor for detecting the impact on the one side of the vehicle, and the third sensor is a second sub sensor for detecting the impact on the one side of the vehicle.

Alternatively, the first sensor may be disposed on one side of the vehicle, the second sensor may be disposed on the one side of the vehicle so that the second sensor is apart from the first sensor, and the third sensor may be disposed on a center of the vehicle so that the third sensor and the second sensor are disposed on almost a same latitudinal line of the vehicle. The first sensor is a main sensor for detecting the impact on the one side of the vehicle, the second sensor is a first sub sensor for detecting the impact on the one side of the vehicle, and the third sensor is a second sub sensor for detecting the impact on the one side of the vehicle.

Alternatively, the first sensor may be disposed on one side of the vehicle, the second sensor may be disposed on the one side of the vehicle so that the second sensor is apart from the first sensor, the third sensor may be disposed on the other side of the vehicle so that the third sensor and the first sensor are disposed on almost a same latitudinal line of the vehicle. The first sensor is a main sensor for detecting the impact on the one side of the vehicle, the second sensor is a first sub sensor for detecting the impact on the one side of the vehicle, and the third sensor is a second sub sensor for detecting the impact on the one side of the vehicle.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A passenger protection system for an automotive vehicle comprising:
a first sensor for detecting an impact of the vehicle in a lateral direction of the vehicle;
a second sensor for detecting the impact of the vehicle in the lateral direction of the vehicle;
a third sensor for detecting the impact of the vehicle in the lateral direction of the vehicle;
a determination element for determining a side collision of the vehicle on the basis of signals outputted from the first to third sensors;
a first communication passage for connecting among the first sensor, the second sensor and the determination element in order to transmit signals outputted from the first sensor and the second sensor to the determination element; and
a second communication passage for connecting between the third sensor and the determination element in order to transmit a signal outputted from the third sensor to the determination element.

2. The system according to claim 1, wherein the determination element determines that the side collision is occurred when the impact of the vehicle corresponding to the signal of each sensor is larger than a predetermined threshold of the sensor.

3. The system according to claim 2, wherein the threshold of the third sensor is smaller than the threshold of the first sensor, and smaller than the threshold of the second sensor.

4. The system according to claim 1, wherein
the first sensor and the second sensor are disposed on one side of the vehicle so that each of the first sensor and the second sensor functions as a satellite sensor,
one of the first sensor and the second sensor functions as a main sensor for determination of the collision, and
the other one of the first sensor and the second sensor functions as a sub sensor for the determination of the collision.

5. The system according to claim 4, wherein
the third sensor is disposed in the determination element, and
the third sensor is an acceleration sensor.

6. The system according to claim 4, wherein
the sub sensor is disposed on a center of the vehicle in the lateral direction of the vehicle.

7. The system according to claim 1, wherein
the first sensor and the second sensor are disposed on one side of the vehicle so that each of the first sensor and the second sensor functions as a satellite sensor, and
the third sensor is disposed on the other side of the vehicle so that the third sensor functions as another satellite sensor.

8. The system according to claim 1, further comprising:
a passenger protection unit functioning on the basis of the determination of the determination element.

9. The system according to claim 1, wherein
the first communication passage is a bus line.

10. The system according to claim 1, wherein
the first sensor is disposed on one side of the vehicle,
the second sensor is disposed on a center of the vehicle so that the second sensor and the first sensor are disposed on almost a same latitudinal line of the vehicle,
the third sensor is disposed on the center of the vehicle so that the third sensor is apart from the second sensor,
the first sensor is a main sensor for detecting the impact on the one side of the vehicle,
the second sensor is a first sub sensor for detecting the impact on the one side of the vehicle, and
the third sensor is a second sub sensor for detecting the impact on the one side of the vehicle.

11. The system according to claim 1, wherein
the first sensor is disposed on one side of the vehicle,
the second sensor is disposed on the one side of the vehicle so that the second sensor is apart from the first sensor,
the third sensor is disposed on a center of the vehicle so that the third sensor and the second sensor are disposed on almost a same latitudinal line of the vehicle,
the first sensor is a main sensor for detecting the impact on the one side of the vehicle,
the second sensor is a first sub sensor for detecting the impact on the one side of the vehicle, and
the third sensor is a second sub sensor for detecting the impact on the one side of the vehicle.

12. The system according to claim 1, wherein
the first sensor is disposed on one side of the vehicle,
the second sensor is disposed on the one side of the vehicle so that the second sensor is apart from the first sensor,
the third sensor is disposed on the other side of the vehicle so that the third sensor and the first sensor are disposed on almost a same latitudinal line of the vehicle,
the first sensor is a main sensor for detecting the impact on the one side of the vehicle,
the second sensor is a first sub sensor for detecting the impact on the one side of the vehicle, and
the third sensor is a second sub sensor for detecting the impact on the one side of the vehicle.
